(19) United States
(12) Patent Application Publication
(10) Pub. No.: US 2018/0254694 A1
(43) Pub. Date: Sep. 6, 2018

(54) Interleaved Phase Shift Modulated DC-DC Converter

(71) Applicant: Dentaray Ltd., Yolneam Llit (IL)

(72) Inventor: Doron CHOMSKY, Rehovot (IL)

(21) Appl. No.: 15/576,829

(22) PCT Filed: May 25, 2016
(86) PCT No.: PCT/IL2016/050546

§ 371 Date: Nov. 26, 2017

Related U.S. Application Data
(60) Provisional application No. 62/169,564, filed on Jun. 2, 2015.

(51) Int. Cl. H02M 1/14; H02M 3/335; H02M 3/28

(52) U.S. Cl. CPC H02M 1/14; H02M 2001/0077; H02M 3/285; H02M 3/335

(57) ABSTRACT

A DC to DC converter constituted of: a control circuitry; a DC power input and return; a DC power output and return; a plurality of inverters, each comprising an input and an output, the inputs of the plurality of inverters coupled in parallel across the DC power input and return; a plurality of transformers, each comprising a primary winding and a secondary winding magnetically coupled to the secondary winding, the primary winding coupled across the output of a respective inverter; and a plurality of rectifiers, each comprising an input and an output, the input of each rectifier coupled across the secondary winding of a respective transformer, wherein the outputs of the plurality of rectifiers are serially coupled between the DC power output and return, and wherein the control circuitry is arranged to control the plurality of inverters to operate at different phases.

### CROSS-REFERENCE TO RELATED APPLICATIONS

This application claims priority from U.S. provisional application Ser. No. 62/169,564, filed Jun. 2, 2015 and entitled “DC TO DC CONVERTER”, the entire contents of which is incorporated herein by reference.

### TECHNICAL FIELD

The invention relates generally to the field of electrical converters, and in particular to a direct-current (DC) to DC converter.

### BACKGROUND

High powered laser tubes require a very high DC voltage to operate. Typically, a low voltage DC power source is present and a DC to DC converter is used to increase the voltage of the power supplied by the low voltage DC power source to a sufficiently high voltage to power the laser tube.

FIG. 1A illustrates a high level schematic diagram of a prior art DC powered laser system 10, comprising: a DC power source 20; an inverter 30; a transformer 40, comprising a primary winding 50 and a secondary winding 60 magnetically coupled to primary winding 50; a full-wave rectifier 70; an inductive element 80; a capacitive element 90; and a laser tube 100. FIG. 1B illustrates a graph 110 of the voltage across the output of full-wave rectifier 70, where the x-axis represents time and the y-axis represents modulation depth. FIGS. 1A-1B are described together. In one embodiment, inverter 30 comprises a bridge circuit of four electronically controlled switches. In another embodiment, full-wave rectifier 70 comprises four diodes. In one embodiment, inductive element 80 comprises an inductor, and is described herein as such. In another embodiment, capacitive element 90 comprises a capacitor, and is described herein as such. In one embodiment, laser tube 100 comprises a CO₂ laser tube.

Input leads of inverter 30 are coupled across power and return leads of DC power source 20 and output leads of inverter 30 are coupled across primary winding 50 of transformer 40. Input leads of full-wave rectifier 70 are coupled across secondary winding 60 of transformer 40. A power lead of the output of full-wave rectifier 70 is coupled to a first end of inductor 80. A second end of inductor 80 is coupled to a first end of capacitor 90 and a first end of laser tube 100. A second end of capacitor 90 and a second end of laser tube 100 are each coupled to a return lead of the output of full-wave rectifier 70.

In operation, inverter 30 is arranged to invert the DC power signal output by DC power source 20 into an alternating-current (AC) power signal, exhibiting a first voltage value. In one embodiment, the frequency of the AC power signal is 10-100 kHz. The voltage of the AC power signal is multiplied by transformer 40 to exhibit a second voltage value, greater than the first voltage value. The AC power signal output across secondary winding 60 of transformer 40, exhibiting the second voltage value, is rectified by full-wave rectifier 70. As illustrated by graph 110 of FIG. 1B, the voltage at the output of full-wave rectifier 70 exhibits a rectified sine wave form with 100% modulation depth, i.e. the rectified peak-to-peak voltage is double the desired DC output voltage. Inductor 80 and capacitor 90 are arranged to filter out residual AC components at the output of full-wave rectifier 70 and to smooth the ripple of the rectified sine wave.

Disadvantageously, due to the 100% modulation depth, a large inductor 80 and capacitor 90 are needed. Additionally, due to the 100% modulation depth, the peak voltage presented across full-wave rectifier 70, and secondary winding 60 of transformer 40, is twice the smoothed out voltage being provided to laser tube 100. As a result, transformer 40 needs to tolerate twice the amount of voltage than necessary and must have an increased voltage isolation, which adds cost and complexity.

It is therefore an object of the present disclosure to overcome at least part of the disadvantages of the prior art.

### SUMMARY OF THE INVENTION

Accordingly, it is a principal object of the present invention to overcome disadvantages of prior art methods and arrangements of DC to DC converters. This is provided in one embodiment by a DC to DC converter comprising: a control circuitry; a DC power input and return; a DC power output and return; a plurality of inverters, each of the plurality of inverters comprising an input and an output, the inputs of the plurality of inverters coupled in parallel across the DC power input and return; a plurality of transformers, each of the plurality of transformers comprising a primary winding and a secondary winding magnetically coupled to the secondary winding, the primary winding coupled across the output of a respective one of the plurality of inverters; and a plurality of rectifiers, each of the plurality of rectifiers comprising an input and an output, the input of each of the plurality of rectifiers coupled across the secondary winding of a respective one of the plurality of transformers, wherein the outputs of the plurality of rectifiers are serially coupled between the DC power output and return, and wherein the control circuitry is arranged to control the plurality of inverters to operate at different phases.

In one embodiment, the plurality of inverters comprises three inverters, the plurality of transformers comprises three transformers and the plurality of rectifiers comprises three rectifiers. In another embodiment, the phase differences between the operation of the plurality of inverters are substantially equal to each other.

In one embodiment, each of the plurality of rectifiers comprises a full wave rectifier.

In one independent embodiment, a direct-current (DC) to DC conversion method is provided, the method comprising: receiving a DC power input signal; inverting the received DC power input signal into a plurality of alternating-current (AC) power signal components exhibiting different phases; rectifying each of the plurality of AC power signal components into a respective DC power signal component; summing the DC power signal components into a DC power output signal; and outputting the DC power output signal.

In one embodiment, the method further comprises multiplying the voltage of each of the plurality of AC power signal components by a respective predetermined value, the rectifying comprising rectifying each of the multiplied AC power signal components. In another embodiment, the plurality of AC power signal components comprises three AC power signal components.

In one embodiment, the phase differences between the plurality of AC power signal components are substantially equal to each other.

In another independent embodiment, a direct-current (DC) to DC converter is provided, the converter comprising: an inversion circuitry arranged to invert a DC power input signal into a plurality of alternating-current (AC) power signal components exhibiting different phases; and a rectification and summation circuitry arranged to: rectify each of the plurality of AC power signal components into a respective DC power signal component; sum the DC power signal components into a DC power output signal; and output the DC power output signal.

In one embodiment, the converter further comprises a voltage multiplication circuitry arranged to multiply the voltage of each of the plurality of AC power signal components by a respective predetermined value, the rectification comprising a rectification of each of the multiplied AC power signal components. In another embodiment, the plurality of AC power signal components comprises three AC power signal components.

In one embodiment, the phase differences between the plurality of AC power signal components are substantially equal to each other.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1A illustrates a high level schematic diagram of a prior art DC powered laser system;

FIG. 1B illustrates a high level graph of a waveform of a DC voltage of the system of FIG. 1A;

FIG. 2A illustrates a high level schematic diagram of a DC to DC converter, according to certain embodiments;

FIGS. 2B-2D illustrate high level graphs of a waveform of DC voltage across the output of the DC to DC converter of FIG. 2A;

FIG. 3 illustrates a high level schematic diagram of a detailed embodiment of the DC to DC converter of FIG. 2A, according to certain embodiments;

FIG. 4 illustrates a high level schematic diagram of a DC powered laser system, according to certain embodiments; and

FIG. 5 illustrates a high level flow chart of a DC to DC conversion method, according to certain embodiments.

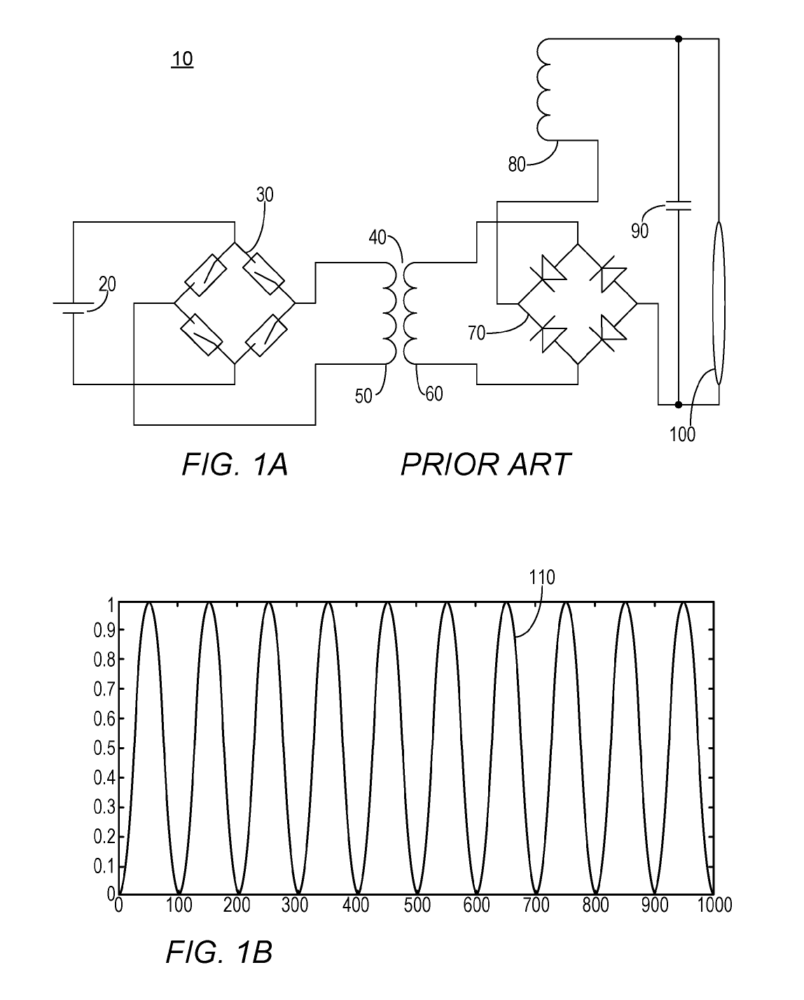

### DETAILED DESCRIPTION OF THE PREFERRED EMBODIMENTS

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

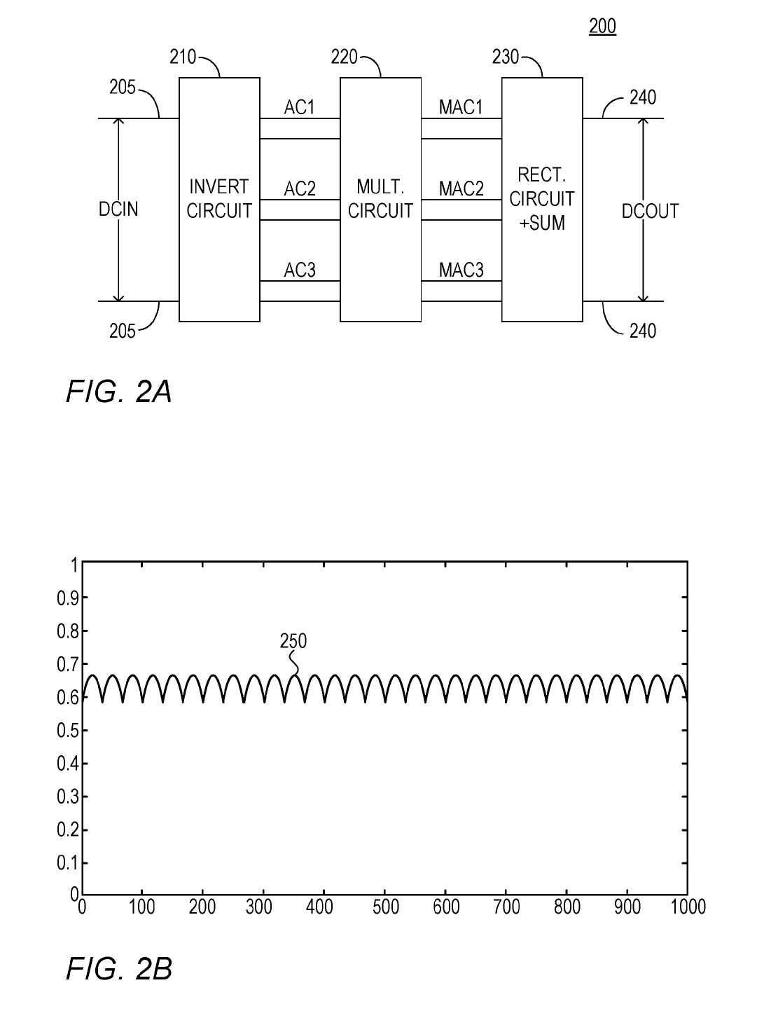

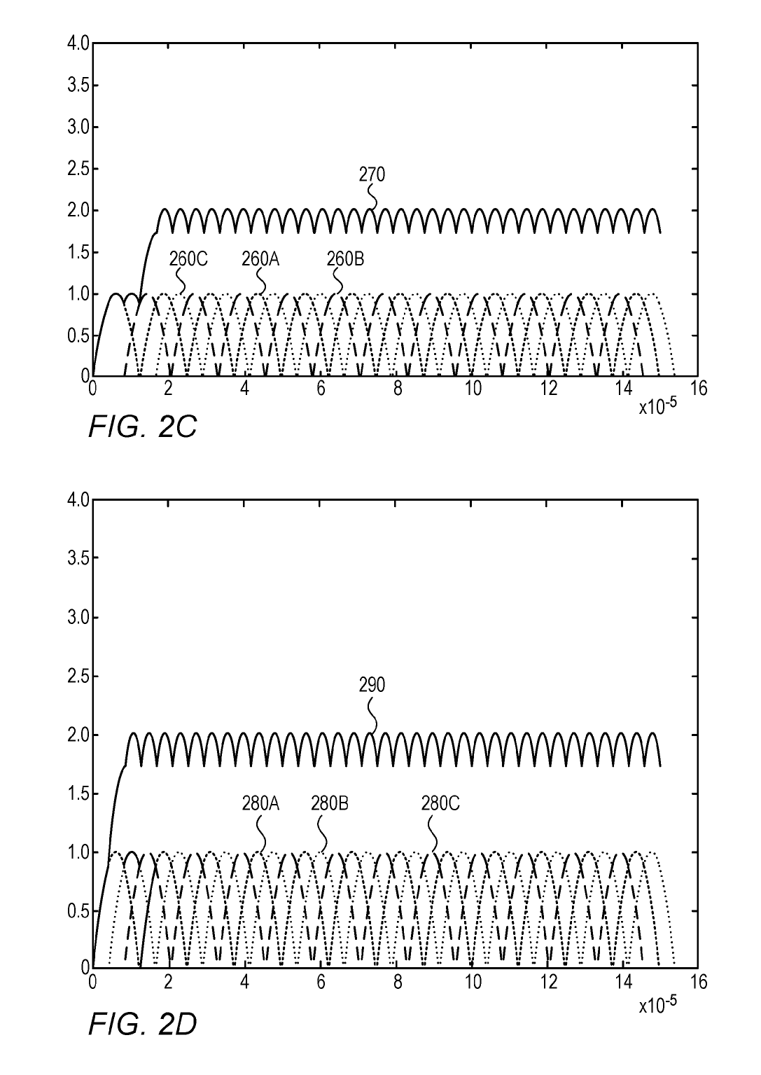

FIG. 2A illustrates a high level schematic diagram of a DC to DC converter 200, comprising: a DC power input and return lead pair 205; an inversion circuitry 210; a voltage multiplication circuitry 220; a rectification and summation circuitry 230; and a DC power output and return lead pair 240. An input of inversion circuitry 210 is coupled across DC power input and return lead pair 205 and an output of inversion circuitry 210 is coupled across an input of voltage multiplication circuitry 220. An output of voltage multiplication circuitry 220 is coupled across an input of rectification and summation circuitry 230 and an output of rectification and summation circuitry 230 is coupled across DC power output and return lead pair 240.

In operation, a DC power signal, denoted DCIN, is received across DC power input and return lead pair 205. Inversion circuitry 210 is arranged to invert DC power signal DCIN into a plurality of AC power signal components, denoted AC1, AC2 and AC3. Preferably, AC power signal components AC1, AC2 and AC3 exhibit a common frequency. In one embodiment, the frequency of each of AC power signal components AC1, AC2 and AC3 is 10-100 kHz. Inversion circuitry 210 is arranged such that AC power signal components AC1, AC2 and AC3 exhibit different phases. Particularly, the phase of AC power signal component AC1 differs from the phase of each of AC power signal components AC2 and AC3, and the phase of AC power signal component AC2 differs from the phase of AC power signal component AC3. In one further embodiment, the phase differences are equal to each other. For example, in an embodiment where AC power signal components AC1, AC2 and AC3 each exhibit a frequency of 40 kHz, i.e. a period of 25 μs, the phase difference in time is about 8.3 μs. Alternatively, the phase difference in time is about 4.15 μs.

Voltage multiplication circuitry 220 is arranged to multiply the voltage of each of AC power signal components AC1, AC2 and AC3 by a respective predetermined value. Preferably, AC power signal components AC1, AC2 and AC3 are each multiplied by the same predetermined value. Further preferably, the predetermined value is greater than 1, i.e. voltage multiplication circuitry 220 increases the voltage of each of AC power signal components AC1, AC2 and AC3. In one embodiment, voltage multiplication circuitry 220 comprises a plurality of transformers, each of the plurality of transformers arranged to multiply the voltage of a respective one of AC power signal components AC1, AC2 and AC3. The multiplied AC power signal components AC1, AC2 and AC3 are denoted respectively MAC1, MAC2 and MAC3.

Multiplied AC power signal components MAC1, MAC2 and MAC3 are each rectified by rectification and summation circuitry 230 into a respective DC power signal component. Rectification and summation circuitry 230 is further arranged to sum the rectified DC power signal components. As described above, AC power signal components AC1, AC2 and AC3 exhibit different phases. As a result, the rectified DC power signal components exhibit corresponding phase differences. The phase differences are arranged such that the sum of the rectified DC power signal components equal an approximately fixed value as a function of time. For example, in the embodiment where the period of AC power signal components AC1, AC2 and AC3 is split into three equal portions, the sum of the rectified DC power signal components will always equal approximately the same value, and the ripple of the summed rectified DC power signal components will be significantly reduced, as illustrated in graph 250 of FIG. 2B where the x-axis represents time and the y-axis represents modulation depth. Particularly, as illustrated, the peak to peak value of the ripple at the output of rectification and summation circuitry 230 is about 10% of the value of the ripple at the output of full-wave rectifier 70 of prior art DC powered laser system 10, illustrated above in graph 110. As will be described below, preferably an additional filter is provided to smooth out the DC power signal output across DC output and return lead pair 240, denoted DCOUT. Additionally, as will be described below, in one embodiment DC power signal DCOUT is used to power a high powered laser tube.

As illustrated in FIGS. 2C-2D, providing a phase difference of ⅓ of the period and providing a phase difference of ⅙ of the period will produce a similar result. FIG. 2C illustrates graphs of AC power signal components AC1, AC2 and AC3 exhibiting phase differences of a third of the AC period, i.e. 2763, the graphs denoted 260A, 260B and 260C, respectively. Additionally, graph 270 illustrates the summed DC signal components. The x-axis denotes time and the y-axis denotes voltage. FIG. 2D illustrates graphs of AC power signal components AC1, AC2 and AC3 exhibiting phase differences of a sixth of the AC period, i.e. 2π/3, the graphs denoted 280A, 280B and 280C, respectively. Additionally, graph 290 illustrates the summed DC signal components. The x-axis denotes time and the y-axis denotes voltage. As illustrated, the ripples of graphs 270 and 290 are substantially equal.

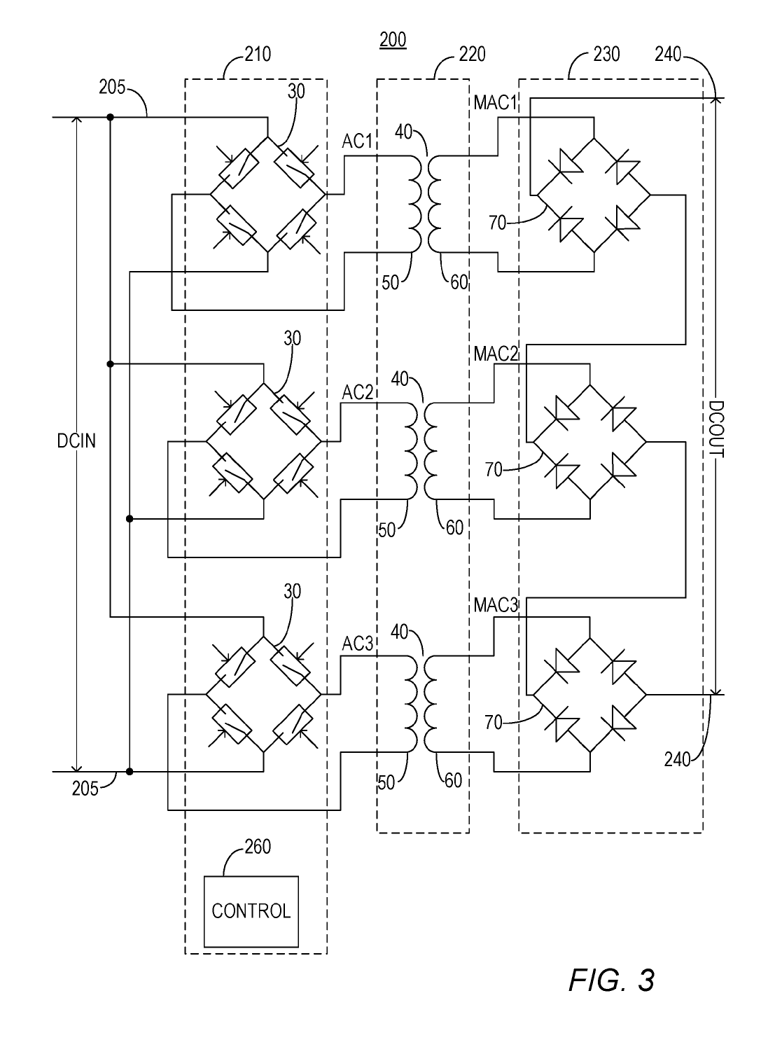

FIG. 3 illustrates a high level schematic diagram of one detailed embodiment of DC to DC converter 200. Particularly, inversion circuitry 210 comprises: a plurality of inverters 30; and a control circuitry 260. Voltage multiplication circuitry 220 comprises a plurality of transformers 40, each comprising a primary winding 50 and a secondary winding 60 magnetically coupled to the respective primary winding 50. Rectification and summation circuitry 230 comprises a plurality of full-wave rectifiers 70. Three inverters 30, three transformers 40 and three full-wave rectifiers 70 are illustrated, however this is not meant to be limiting in any way and any number inverters 30, and corresponding number of transformers 40 and full-wave rectifiers 70 can be provided without exceeding the scope.

Input leads of inverters 30 are coupled in parallel across DC power input and return lead pair 205, i.e. the power leads of the inputs of inverters 30 are commonly coupled to the input lead of DC power input and return lead pair 205 and the return leads of the inputs of inverters 30 are commonly coupled to the return lead of DC power input and return lead pair 205. Each inverter 30 is in communication with control circuitry 260 (connections not shown). In one embodiment, each inverter 30 comprises a plurality of electronically controlled switches arranged in a bridge configuration and the control input of each electronically controlled switch is in communication with control circuitry 260. Each primary winding 50 is coupled across a pair of output leads of a respective one of inverters 30. Input leads of each full-wave rectifier 70 are coupled across secondary winding 60 of a respective transformer 40. Output leads of full-wave rectifiers 70 are serially coupled between DC power output and return lead pair 240. Particularly, the power lead of the output of a first full-wave rectifier 70 is coupled to the output lead of DC power output and return lead pair 240. The return lead of the output of the first full-wave rectifier 70 is coupled to the power lead of the output of a second full-wave rectifier 70. The return lead of the output of the second full-wave rectifier 70 is coupled to the power lead of the output of a third full-wave rectifier 70. The return lead of the output of the third full-wave rectifier 70 is coupled to the return lead of DC power output and return lead pair 240.

As described above, inverters 30 invert DC power input signal DCIN into a plurality of AC power signal components AC1, AC2 and AC3, responsive to control circuitry 260. Control circuitry 260 is arranged to control inverters 30 such that AC power signal components AC1, AC2 and AC3 exhibit different phases, as described above. Transformers 40 multiply the voltages of AC power signal components by the respective predetermined value, i.e. the turns ratio between the primary winding 50 and the secondary winding 60. AC power signal components MAC1, MAC2 and MACS, exhibiting the multiplied voltages, are rectified by full-wave rectifiers 70 into DC power signal components, the DC power signal components being summed together to form DC power output signal DCOUT due to the serial connection of the outputs of full-wave rectifiers 70.

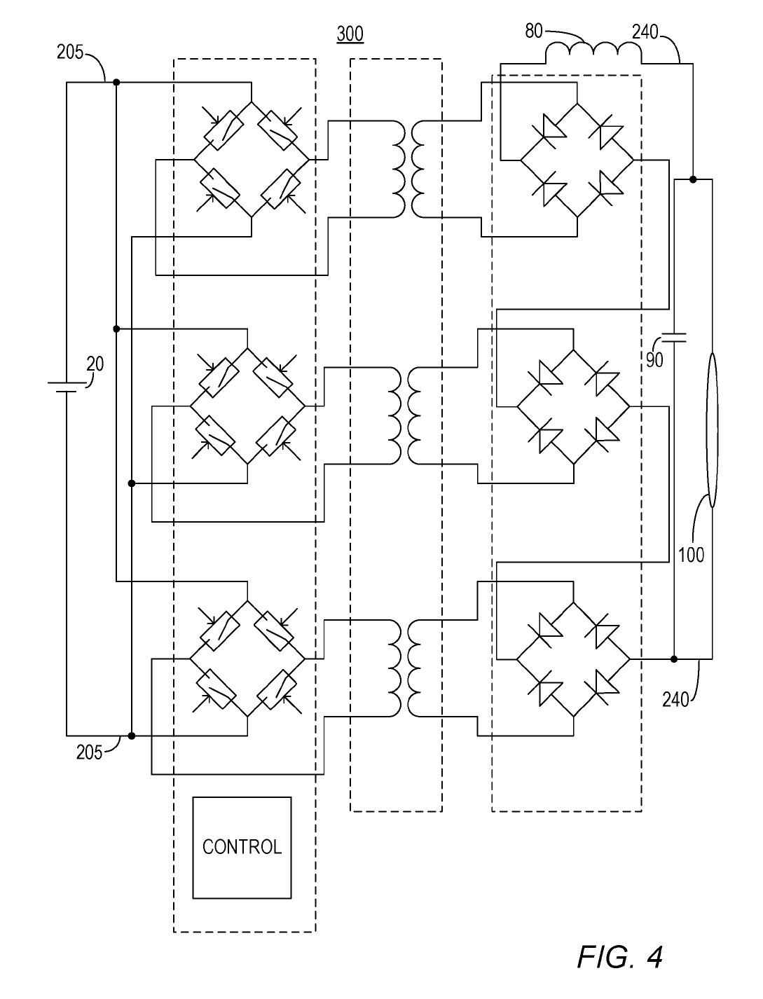

FIG. 4 illustrates a high level schematic diagram of a DC powered laser system 300, according to certain embodiments. DC powered laser system 300 is in all respects similar to DC to DC converter 200 of FIG. 3, with the addition of a DC power source 20, an inductance element 80, a capacitance element 90 and a laser tube 100. As described above, in one embodiment inductance element 80 comprises an inductor and capacitance element 90 comprises a capacitor. DC power input and return lead pair 205 is coupled across DC power source 20. The output lead of DC power output and return lead pair 240 is coupled to a first end of inductor 80. A second end of inductor 80 is coupled to a first end of capacitor 90 and a first end of laser tube 100. A second end of capacitor 90 and a second end of laser tube 100 are each coupled to the return lead of DC power output and return lead pair 240. The operation of DC powered laser system 300 is in all respects similar to DC to DC converter 200 with the addition that the DC input power is received from DC power source 20 and the DC output power is supplied to laser tube 100. Additionally, inductor 80 and capacitor 90 remove residual AC components from the output DC power signal and smooth out the ripple of the DC voltage across the series connected full-wave rectifiers 70.

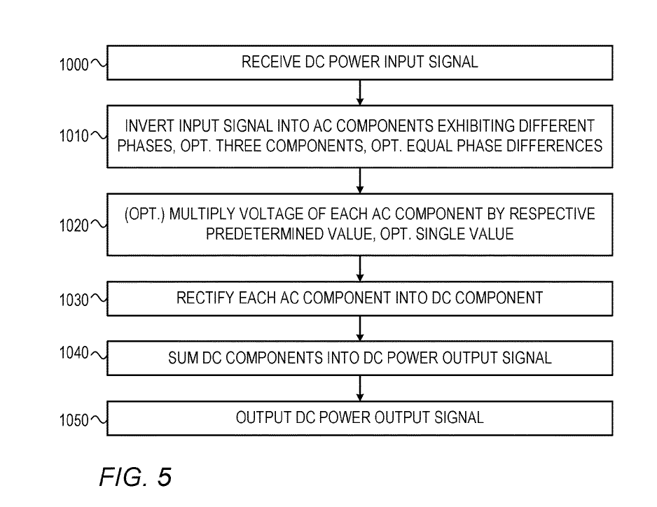

FIG. 5 illustrates a high level flow chart of a DC to DC conversion method. In stage 1000, a DC power input signal is received. In stage 1010, the received DC power input signal of stage 1000 is inverted into a plurality of AC power signal components exhibiting different phases, optionally three AC power signal components. Optionally, the phase differences between the different AC power signal components are substantially equal to each other. As described above, in one embodiment the phase difference, in time, between subsequent AC power signal components equals a third of the period of the AC power signal components.

In optional stage 1020, the voltage of each of the plurality of AC power signal components is multiplied by a respective predetermined value. Optionally, the voltages are multiplied by a signal predetermined value.

In stage 1030, each of the plurality of AC power signal components of stage 1010, or optional stage 1020, is rectified into a DC power signal component. In stage 1040, the plurality of rectified DC power signal components of stage 1030 are summed together into a DC power output signal. As described above, because of the phase differences between the signal components, the sum will be equal to an approximately fixed value as a function of time, with a reduced ripple. In stage 1050, the DC power output signal of stage 1040 is output.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

The terms “include”, “comprise” and “have” and their conjugates as used herein mean “including but not necessarily limited to”.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description.

1. A direct-current (DC) to DC converter comprising:
a control circuitry;
a DC power input and return;
a DC power output and return;
a plurality of inverters, each of said plurality of inverters comprising an input and an output, said inputs of said plurality of inverters coupled in parallel across said DC power input and return;
a plurality of transformers, each of said plurality of transformers comprising a primary winding and a secondary winding magnetically coupled to said secondary winding, said primary winding coupled across said output of a respective one of said plurality of inverters; and
a plurality of rectifiers, each of said plurality of rectifiers comprising an input and an output, said input of each of said plurality of rectifiers coupled across said secondary winding of a respective one of said plurality of transformers,
wherein said outputs of said plurality of rectifiers are serially coupled between said DC power output and return, and
wherein said control circuitry is arranged to control said plurality of inverters to operate at different phases.

2. The converter of claim 1, wherein said plurality of inverters comprises three inverters, said plurality of transformers comprises three transformers and said plurality of rectifiers comprises three rectifiers.

3. The converter of claim 1, wherein the phase differences between said operation of said plurality of inverters are substantially equal to each other.

4. The converter of claim 1, wherein each of said plurality of rectifiers comprises a full wave rectifier.

5. A direct-current (DC) to DC conversion method, the method comprising:
receiving a DC power input signal;
inverting said received DC power input signal into a plurality of alternating-current (AC) power signal components exhibiting different phases;
rectifying each of said plurality of AC power signal components into a respective DC power signal component;
summing said DC power signal components into a DC power output signal; and
outputting said DC power output signal.

6. The method of claim 5, further comprising multiplying the voltage of each of said plurality of AC power signal components by a respective predetermined value, said rectifying comprising rectifying each of said multiplied AC power signal components.

7. The method of claim 5, wherein said plurality of AC power signal components comprises three AC power signal components.

8. The method of claim 5, wherein the phase differences between said plurality of AC power signal components are substantially equal to each other.

9. A direct-current (DC) to DC converter comprising:
an inversion circuitry arranged to invert a DC power input signal into a plurality of alternating-current (AC) power signal components exhibiting different phases; and
a rectification and summation circuitry arranged to:
rectify each of said plurality of AC power signal components into a respective DC power signal component;
sum said DC power signal components into a DC power output signal; and
output said DC power output signal.

10. The converter of claim 9, further comprising a voltage multiplication circuitry arranged to multiply the voltage of each of said plurality of AC power signal components by a respective predetermined value, said rectification comprising a rectification of each of said multiplied AC power signal components.

11. The converter of claim 9, where said plurality of AC power signal components comprises three AC power signal components.

12. The converter of claim 9, wherein the phase differences between said plurality of AC power signal components are substantially equal to each other.
